(19) United States
(12) Patent Application Publication
(10) Pub. No.: US 2017/0159443 A1
(43) Pub. Date: Jun. 8, 2017

(54) CONTOURED SURFACE ANNULAR SECTION OF A GAS TURBINE

(71) Applicant: MTU Aero Engines AG, Munich (DE)

(72) Inventors: Martin Pernleitner, Dachau (DE); Inga Mahle, Munich (DE); Nina Wolfrum, Feldkirchen (DE); Markus Brettschneider, Karlsfeld (DE); Markus Schlemmer, Mainburg/Sandelzhausen (DE)

(21) Appl. No.: 15/367,799

(22) Filed: Dec. 2, 2016

(30) Foreign Application Priority Data
Dec. 7, 2015 (DE) 102015224420.2

(51) Int. Cl. F01D 5/14; F04D 29/54; F04D 29/32; F01D 5/02; F01D 9/04

(52) U.S. Cl. CPC F01D 5/141; F01D 5/02; F01D 9/041; F04D 29/324; F04D 29/544; F05D 2220/32; F05D 2240/125; F05D 2240/307

(57) ABSTRACT

The invention relates to a blade or vane ring for a gas turbine having a plurality of blades or vanes that are arranged next to one another in the peripheral direction (UR), wherein blades or vanes have a flow segment extending essentially in the radial direction, these blades or vanes having a convex suction side, a concave pressure side, a leading edge and a trailing edge, wherein the suction side and the pressure side are joined together by the leading edge and the trailing edge, wherein the blades or vanes transition into an annular segment of the blade or vane ring radially inside and/or radially outside, wherein annular segment connects a first blade or vane (12) and a second blade or vane, which are adjacent to one another, between the suction side of the first blade or vane and the pressure side of the second blade or vane.

The present invention relates to a blade or vane ring for a gas turbine, in particular an aircraft gas turbine, having a plurality of blades or vanes that are arranged next to one another in the peripheral direction (UR), wherein the blades or vanes have a flow segment, the so-named blade or vane element that extends essentially in the radial direction, these blades or vanes having a convex suction side, a concave pressure side, a leading edge, and a trailing edge, wherein the suction side and the pressure side are joined together by the leading edge and the trailing edge, wherein the blades or vanes transition into an annular segment of the blade or vane ring radially inside and/or radially outside, wherein the annular segment joins a first blade or vane and a second blade or vane that are adjacent to one another, between the suction side of the first blade or vane and the pressure side of the second blade or vane. Such an annular segment is also designated a radially outer shroud or a radially inner shroud or “end wall”.

Directional indications such as “axial” or “axially”, “radial” or “radially”, and “peripheral” are basically to be understood as referred to the machine axis of the gas turbine, as long as something different does not ensue explicitly or implicitly from the context. Other indications such as “front” or “back” basically refer to the primary flow direction of gas in a gas turbine or in turbine or compressor stages belonging thereto, as long as something different does not ensue explicitly or implicitly from the context.

In the case of blade or vane rings of gas turbines, flows result in a direction of primary flow that runs essentially tangentially to the blading, as well as flows crosswise thereto and corresponding flow vortices. These cross-flows and flow vortices, which are together also called secondary flow, are disruptive and negatively affect the efficiency of the gas turbine, due to unfavorable aerodynamic flow conditions.

The object of the invention is to provide a blade or vane ring, in which the above disadvantages can be avoided.

In order to achieve this object, it is proposed that the annular segment is designed as a contoured surface area with different heights in the radial direction, wherein the annular segment has a highest surface area section and a deepest surface area section, the highest surface area section being formed directly adjacent to the pressure side of the second blade or vane.

In the sense of the present invention, the “radially highest surface area section” is understood to mean a surface area section of the annular segment that extends the furthest into the flow channel formed between two blades or vanes that are adjacent in the peripheral direction. Correspondingly, a “radially deepest surface area section” is understood to mean a surface area section that extends at least as far into the flow channel formed between two blades or vanes that are adjacent in the peripheral direction. In other words, the terms “highest” and “deepest” here refer to the volume of the flow channel. In the case of a radially inner annular segment, to which the present invention preferably refers, the “radially highest surface area section” therefore is further distant from the rotational or machine axis of the turbomachine than the “radially deepest surface area section, when the blade or vane ring is mounted as intended in a turbomachine, whereas the inverse applies specifically in a radially outer annular segment.

Such an embodiment of the annular segments between two adjacent blades or vanes leads to an improved aerodynamic flow into the edge regions of the pressure sides of the blades or vanes. The highest surface area section or a highest point of the annular segment in this case is applied specifically to the pressure side of the blade or vane profile.

Preferably, the highest surface area section lies between the pressure side and an imaginary connection line which joins the leading edge and the trailing edge of the second blade or vane.

In an enhancement, it is proposed that the deepest surface area section is arranged adjacent to the suction side of the first blade or vane, the annular segment having an increasing profile from the deepest surface area section relative to the suction side.

What is stated here with reference to a first blade or vane and a second blade or vane applies, of course, to each pair of blades or vanes of the blade or vane ring that is formed by two adjacent blades or vanes. The use of “first” and “second” serves only to better describe the adjacent blades or vanes; in no way does it represent, however, a limitation to two specific blades or vanes of the blade or vane ring. In this respect, the configuration of all annular segments between the blades or vanes of the blade or vane ring is the same.

The position of the highest surface area section is preferably selected such that the highest surface area sections, at least in parts thereof and preferably completely, lie in an axial region that extends from a maximum 15% of the axial extent of the blade or vane upstream to a maximum 15% of the axial extent of the blade or vane downstream when referred to an imaginary connection line, which joins the center points of a cross-sectional surface area of the blades or vanes in the peripheral direction (UR). In particular, the position of the highest surface area sections can be selected such that the imaginary connection line intersects the highest surface area sections.

The deepest surface area sections can lie in front of the connection line in the axial direction (AR). Usually, the imaginary connection line does not intersect the deepest surface area sections.

It is further preferred that the contour of the annular segment decreases from the highest surface area section from along the pressure side of the second blade or vane to the leading edge and to the trailing edge of the second blade or vane and to the suction side of the first blade or vane.

Referred to a zero line, it is proposed that the highest surface area section has a greater height than the depth or negative height of the deepest surface area section; in particular, the absolute value (quantity) of the height of the highest surface area section is approximately double the absolute value (quantity) of the depth or negative height of the deepest surface area section.

The invention also relates to a rotating blade ring of a turbine stage of a gas turbine, in particular an aircraft gas turbine, wherein the rotating blade ring is designed as a blade ring having one of the above-described features.

Further, the invention relates to a guide vane ring of a turbine stage of a gas turbine, in particular an aircraft gas turbine, wherein the guide vane ring is designed as a vane ring having one of the above-described features.

Finally, the invention also relates to a gas turbine, in particular an aircraft gas turbine that has at least one blade or vane ring or rotating blade ring or guide vane ring having one of the above-described features.

The invention will be described below with reference to the attached figures by way of example and not in any limiting manner.

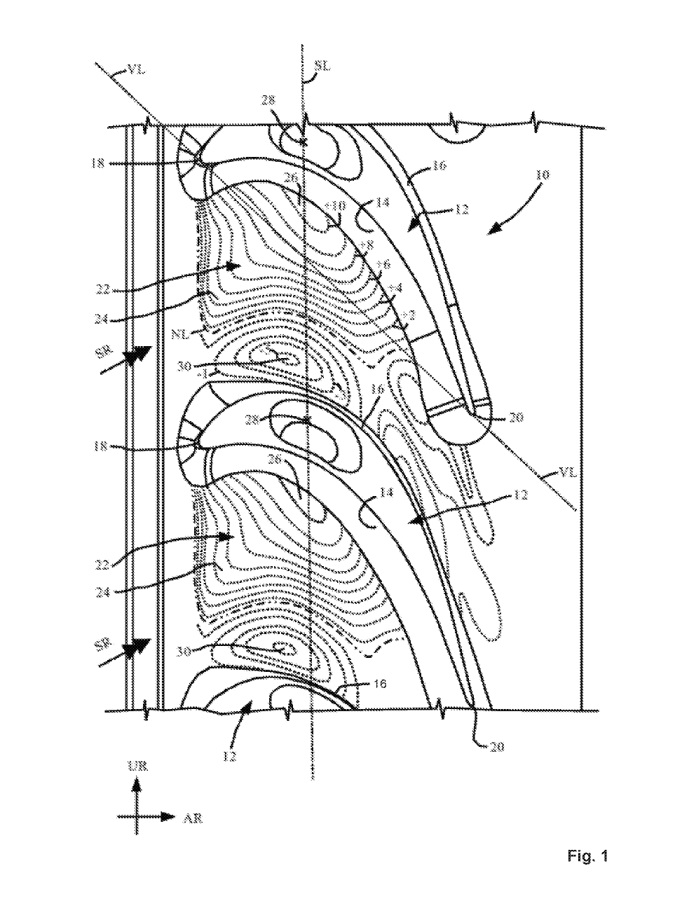

FIG. 1 shows a simplified schematic perspective illustration of an excerpt of a blade or vane ring with contour lines that represent the contour of an annular segment.

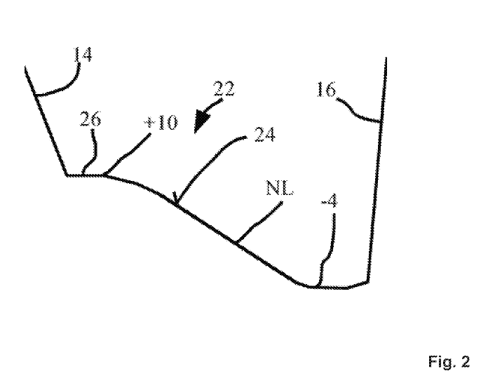

FIG. 2 shows a simplified qualitative lengthwise profile of an annular segment between two blades or vanes along a line SL of FIG. 1.

A blade or vane ring 10 shown partially in FIG. 1 comprises a plurality of blades or vanes 12 arranged next to one another in the peripheral direction UR. The blades or vanes 12 have a respective pressure side 14, a suction side 16, as well as a leading edge 18 and a trailing edge 20. Between two adjacent blades or vanes 12 lies an annular segment 22 of blade or vane ring 10, between suction side 16 of a first blade or vane (bottom blade or vane in FIG. 1) and pressure side 14 of a second blade or vane 12 (top blade or vane in FIG. 1). The annular segment 10 is a surface area that joins together two adjacent blades or vanes 12 and extends in the peripheral direction UR and in the ring axial direction AR. The blades or vanes 12 and the annular segments 22 lying between them are preferably formed in one piece with one another; in particular, the blade or vane ring 10 can be manufactured from one casting or from a plurality of castings.

The surface-area annular segment 22 has a contoured surface 24 facing an annular space through which gas flows and into which the blades or vanes 12 project in the radial direction. Contour lines are plotted in FIG. 1 for illustration, wherein a zero line NL is represented by a dot-dash line. Starting from the zero line NL, the annular segment 22 or its surface 24 rises outwardly in the radial direction, which is illustrated by the dotted contour lines +2 to +10. In this exemplary embodiment, in which an inner shroud is shown, the annular segment 22 or its surface deepens inwardly, starting from the zero line in the radial direction, which is illustrated by the dashed contour lines −1 to −5. The numbers used for the contour lines are merely a qualitative illustration and do not reproduce any real quantitative values. A notation of +2 thus does not mean that it involves 2 units of a specific measurement system such as e.g., millimeters or tenths of millimeters.

The annular segment 22 has a highest surface area section 26 indicated by the contour line +10. This highest surface area section 26 is applied directly to the pressure side 14 of the blade or vane 12. If one takes an imaginary connection line VL, which joins the leading edge 18 and the trailing edge 20 of the blade or vane 12, the highest surface area section 26 in the peripheral direction UR lies between this connection line VL and the pressure side 14; preferably, the highest surface area section 26 lies completely, thus with its entire surface area (corresponding to approximately the boundary of the contour line +10) within a contour that is formed by pressure side 14 and connection line VL. If one assumes for adjacent blades or vanes 12 a respective center point 28 of a cross-sectional surface area of the blade or vane profile and connects these center points 28 in the peripheral direction UR, this center-point connection line SL will intersect the highest surface area section 26.

The annular segment 22 or its surface 24 further has a deepest surface area section 30 that is indicated by the contour line −5. This deepest surface area section 30 lies adjacent to suction side 16 of blade or vane 12. Of course, the deepest surface area section 30 is not applied directly to the suction side 16, but is separated from the suction side 16 in the peripheral direction UR. The deepest surface area section 30 preferably also lies in front of the center-point connection line SL in the axial direction AR, whereby the reference “in front of” refers to the direction of primary flow of gas through the blade or vane ring 10, which is illustrated in FIG. 1 by the double arrow SR.

Starting from the highest surface area section 26, the annular segment 22 or the surface 24 thereof decreases along the pressure side 14 to the leading edge 18 and to the trailing edge 20. Further, annular segment 22 also decreases in the peripheral direction toward suction side 16 of the adjacent blade or vane 12, in particular down to the level of the deepest surface area section 30, from where the annular segment increases again slightly to suction side 16.

If one proceeds from the circumstance that the same distance is present between two contour lines in the radial direction both in the plus direction as well as in the minus direction, the highest surface area section 26 has a greater height than the depth or negative height of the deepest surface area section 30; in particular, the height of the highest surface area section 26 is approximately double the depth or negative height of the deepest surface area section 30. In this case, the height or the depth will be compared to one another as absolute values (quantities), without paying attention to the corresponding sign relative to the zero line.

FIG. 2 shows a simplified lengthwise profile in the peripheral direction UR along the center-point connection line SL of FIG. 1 between pressure side 14 of the second (top in FIG. 1) blade or vane 12 and suction side 16 of the first (bottom in FIG. 1) blade or vane 12. It can be seen from this profile of the surface 24 of annular segment 22 that the highest surface area section 26 connects directly to pressure side 14 of the second blade or vane 12. In this example of embodiment, the highest surface area section 26 forms a type of plateau at the illustrated level +10 referred to the zero line NL.

Of course, this highest surface area section 26 need not necessarily be formed as planar, but can also have a curvature. In this case, the curvature is so slight, however, that no place in the highest surface area section 26 reaches the level +12 or in fact exceeds it. If the highest surface area section has a singular high point, then it is applied preferably directly at pressure side 14 of blade or vane 12.

The profile of surface 24 then decreases from the highest surface area section 26 in the direction of suction side 16 of the first blade or vane 12 with partially different slopes, passes the zero level at NL and again decreases down to the level −5. Starting from this level of −5, the profile of surface 24 then slightly increases in the direction of suction side 16 before annular segment 22 transitions into suction side 16 of the first blade or vane 12.

In the schematic sectional view of FIG. 2, pressure side 14 and suction side 16 of the two blades or vanes 12 are represented as linear. However, this need not be the case. Thus, for structural-mechanical reasons, it may be advantageous, for example, to allow pressure side 14 and/or suction side 16 to transition into annular segment 22 by a so-named fillet, which has a rounding radius similar to a flute groove. Such fillets, however, shall be a component of the blade or vane 12 and not of annular segment 22 according to the present invention.

Due to the proposed contouring of annular segment 22 between two adjacent blades or vanes 12 of a blade or vane ring, by the arrangement of the highest surface area section 26 directly connecting to pressure side 14, improved aerodynamic flow ratios can be achieved in particular, which lead to an improved efficiency and an improved capacity of the gas turbine.

### LIST OF REFERENCE NUMBERS

10 Blade or vane ring
12 Blade or vane
14 Pressure side
16 Suction side
18 Leading edge
20 Trailing edge
22 Annular segment
24 Surface
26 Highest surface area section
28 Center point
30 Deepest surface area section
AR Axial direction
NL Zero level or zero line
UR Peripheral direction
VL Connection line
SL Center-point connection line
SR Primary flow line

1. A blade or vane ring (10) for a gas turbine having a plurality of blades or vanes (12) that are arranged next to one another in the peripheral direction (UR), wherein blades or vanes (12) have a flow segment extending substantially in the radial direction, these blades or vanes having a convex suction side (16), a concave pressure side (14), a leading edge (18) and a trailing edge (20), wherein the suction side (16) and the pressure side (14) are joined together by the leading edge (18) and the trailing edge (20), wherein the blades or vanes (12) transition into an annular segment (22) of the blade or vane ring (10) radially inside and/or radially outside, wherein the annular segment (22) connects a first blade or vane (12) and a second blade or vane (12), which are adjacent to one another, between the suction side (16) of the first blade or vane (12) and the pressure side (14) of the second blade or vane (12), wherein the annular segment (22) is a contoured surface area (24) having different heights in the radial direction, wherein the annular segment (22) has a highest surface area section (26) and a deepest surface area section (30), wherein the highest surface area section (26) is formed directly bounding the pressure side (14) of the second blade or vane (12).

2. The blade or vane ring (10) according to claim 1, wherein the highest surface area section (26) lies between the pressure side (14) and an imaginary connection line (VL) that joins the leading edge (18) and the trailing edge (20) of the second blade or vane (12).

3. The blade or vane ring (10) according to claim 1, wherein the deepest surface area section (30) is arranged adjacent to the suction side (16) of the first blade or vane (12), wherein the annular segment (22) has an increasing profile from the deepest surface area section (30) to the suction side (16).

4. The blade or vane ring (10) according to claim 1, wherein the highest surface area section (26), at least in parts thereof and preferably completely, lies in an axial region that extends from a maximum 15% of the axial extent of the blade or vane (12) upstream to a maximum 15% of the axial extent of the blade or vane (12) downstream referred to an imaginary connection line (SL), which joins the center points of a cross-sectional surface area of the blades or vanes (12) in the peripheral direction (UR).

5. The blade or vane ring (10) according to claim 4, wherein the deepest surface area sections (30) lie in front of the connection line (SL) in the axial direction (AR).

6. The blade or vane ring (10) according to claim 1, wherein the contour of annular segment (22) decreases from the highest surface area section (26) from along pressure side (14) of the second blade or vane (12) to the leading edge (18) and to the trailing edge (20) of the second blade or vane (12) and to the suction side (16) of the first blade or vane (12).

7. The blade or vane ring (10) according to claim 1, wherein, referred to a zero line (NL), the highest surface area section (26) has a greater height (+10) than the depth or negative height (−5) of the deepest surface area section (30); the absolute value of the height of the highest surface area section (26) is approximately double the absolute value of the depth or negative height of the deepest surface area section.

8. The blade or vane ring (10) according to claim 1, wherein the blade or vane ring (10) is configured and arranged as a rotating blade ring of a turbine stage of a gas turbine.

9. The blade or vane ring (10) according to claim 1, wherein the blade or vane ring (10) is configured and arranged as a guide vane ring of a turbine stage of a gas turbine.

10. The blade or vane ring (10) according to claim 1, wherein the blade or vane ring (10) is configured and arranged as a rotating blade ring or a guide vane ring of a gas turbine.
